(19) United States
(12) Patent Application Publication
(10) Pub. No.: US 2020/0357183 A1
(43) Pub. Date: Nov. 12, 2020

(54) Methods, Systems and Apparatuses for Viewing Content in Augmented Reality or Virtual Reality

(71) Applicant: Michael Weber, Austin, TX (US)

(72) Inventor: Michael Weber, Austin, TX (US)

(21) Appl. No.: 16/868,507

(22) Filed: May 6, 2020

Related U.S. Application Data
(60) Provisional application No. 62/844,118, filed on May 6, 2019.

(51) Int. Cl. G06T 19/00; G06F 3/01; G02B 27/01

(52) U.S. Cl. CPC G06T 19/006; G02B 2027/0178; G02B 27/0172; G06F 3/013

(57) ABSTRACT

Methods, systems and apparatuses for viewing content, such as electronic documents, in a virtual view, such as a virtual view presented to a user through an augmented reality headset and/or a virtual reality headset.

### CROSS-REFERENCE TO RELATED APPLICATIONS

This application claims the benefit and priority under 35 U.S.C. 119(e) of U.S. Provisional Application No. 62/844,118, filed May 6, 2019, the entire contents of which are incorporated by reference herein in its entirety.

### BACKGROUND

### A. Technical Field

The present invention pertains generally to improved systems, apparatuses and methods for viewing and interacting with electronic documents and other content using augmented reality (AR) or virtual reality (VR).

### B. Background of the Invention

The proliferation of computers has forever changed the way people view and manage content, such as documents and application data. Modern operating systems that support windows for different applications and documents allow users to have a number of electronic documents open at a given time, some of which can be viewed concurrently on the computer display. Power users often have multiple screens/monitors attached to a single computer so that they have even more space for viewing electronic documents and application data. However, multiple screens increase the costs of computer systems, the power drawn by such systems and reduce the portability of such systems.

Augmented reality (AR) and virtual reality (VR) headsets have the potential to similarly change the way people interact with and view applications and content. The present invention discloses various techniques for more efficient interaction with computing applications and documents using an AR/VR headset. The present invention also discloses techniques for enhancing a user's view using an AR/VR headset.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1A is a perspective view of an AR headset 100 according to embodiments of the invention.

FIG. 1B is a block diagram of some of the hardware components of an AR headset 100 according to embodiments of the invention.

FIG. 2 is a representation of a virtual view 290 as seen through an AR/VR headset according to embodiments of the invention.

FIG. 3 is a representation of a virtual view 390 as seen through an AR/VR headset according to embodiments of the invention.

FIG. 4A is a representation of a virtual view 490 as seen through an AR/VR headset according to embodiments of the invention.

FIG. 4B is a representation of a virtual view 490 as seen through an AR/VR headset according to embodiments of the invention.

FIG. 4C is a close-up view of tiles 420A and 420B from FIG. 4B according to embodiments of the invention.

FIG. 4D is a close-up view of two tiles displayed in a virtual view according to embodiments of the invention.

FIG. 4E is a close-up view of two tiles displayed in a virtual view according to embodiments of the invention.

FIG. 5A is a representation of displaying electronic documents in virtual tiles displayed in a software application executing on a tablet computer 555 according to embodiments of the invention.

FIG. 5B is a representation of displaying electronic documents in virtual tiles displayed in a software application executing on a tablet computer 555 according to embodiments of the invention.

FIG. 6 is an example data structure for an electronic document according to embodiments of the invention.

FIG. 7 is a flowchart of a method 700 for displaying multiple tiles in a virtual view according to embodiments of the invention.

FIG. 8 is a representation of a virtual view 890 as seen through an AR/VR headset according to embodiments of the invention.

FIG. 9 is a flowchart of a method 900 for accessing and displaying supplemental content in a virtual view according to embodiments of the invention.

FIG. 10 represents a virtual view 1090 provided by an AR/VR headset according to embodiments.

FIG. 11 is a flowchart of a method 1100 for displaying supplemental content according to embodiments of the invention.

FIG. 12 is a flowchart of a method 1200 for enhancing a user's vision according to embodiments of the invention.

FIG. 13 is a representation of a virtual view 1300 as seen through an AR/VR headset according to embodiments of the invention.

FIGS. 14A-C represents a view target 1415 that is displayed at different locations within a user's field of view 1400 according to embodiments of the invention.

FIG. 15 represents a magnified view 1510 displayed in the user's field of view through a virtual view provided by an AR/VR headset according to embodiments of the invention.

### DETAILED DESCRIPTION

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be constructed/implemented in a variety of ways. Accordingly, the figures described herein are illustrative of specific embodiments of the invention and are meant to avoid obscuring the invention.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The present inventions provide systems, apparatuses, user interfaces and methods that improve upon augmented reality (AR) and/or virtual reality (VR) devices and augmented/virtual environments. In embodiments, the present invention improves upon AR/VR headsets by providing novel systems, apparatuses, user interfaces and methods for displaying electronic documents in a virtual view provided by the AR/VR headset. In embodiments, the present invention provides users with novel techniques and interfaces for viewing and interacting with electronic documents using AR/VR headsets that are user friendly and improve efficiency for the users of such devices.

As discussed further herein, various embodiments disclosed herein may be implemented as part of an AR or VR headset. In embodiments, various aspects of the invention may be implemented in hardware and/or software. In embodiments, the software may be part of the system level software (e.g., part of the operating system) or application software. In embodiments, the software is stored in a non-transitory computer readable medium, such as a memory (volatile or non-volatile), which is accessibly by a processing circuit. In embodiments, the processing circuit comprises one or more processors such as, but not limited to, a central processing unit (CPU), graphics processing unit (GPU), digital signal processor (DSP), custom application-specific integrated circuit (ASIC) or combinations thereof.

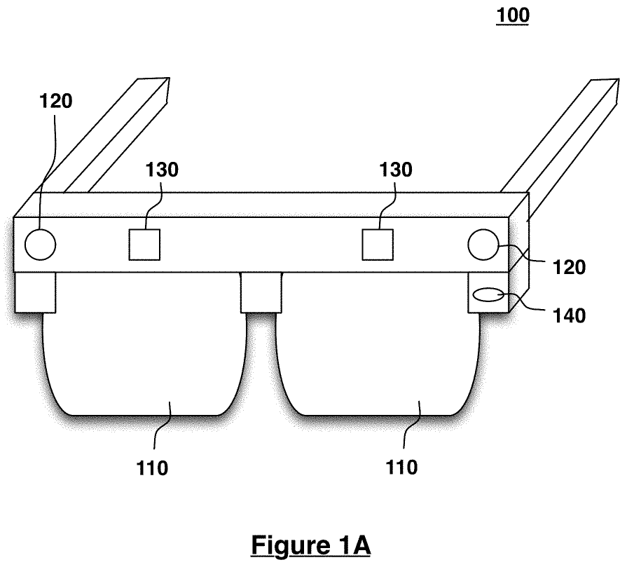

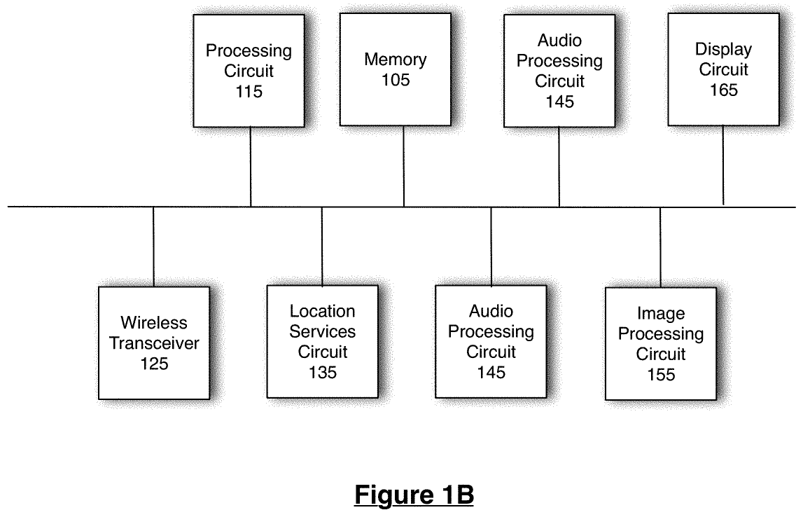

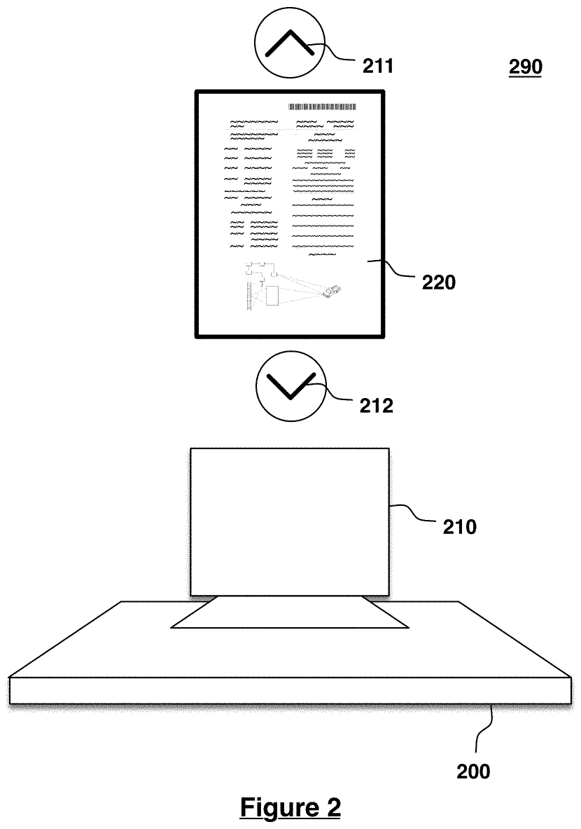

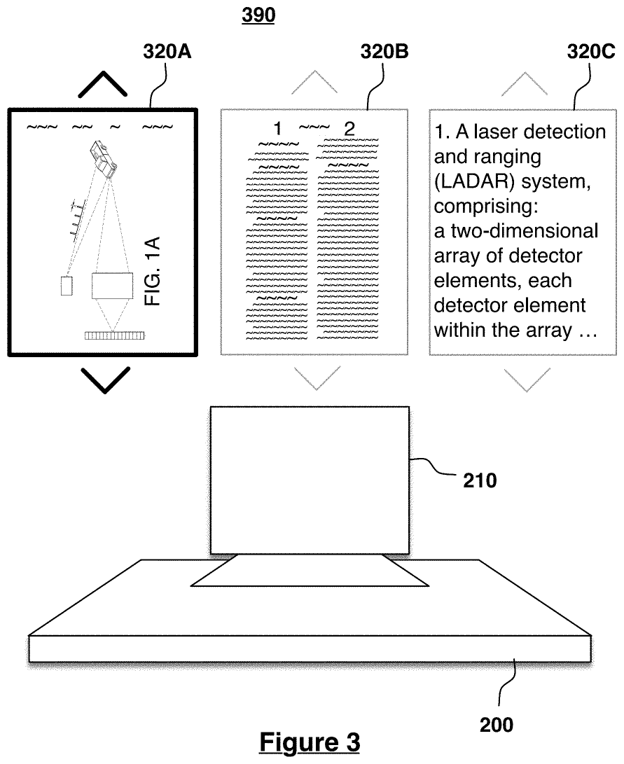

FIG. 1A is a perspective view of a headset 100 according to embodiments of the invention. In embodiments, the headset 100 is comprised of one of more transparent lenses 110 through which a user can see the natural environment. In embodiments, lenses 110 may be made from materials that are well known in the art, such as glass, plastic, etc. In embodiments, lenses 110 may comprise one or more waveguides to reflect light projected by the headset 100 into the user's eyes to implement a virtual view as is known in the art. In embodiments, lenses 110 may be omitted altogether.

In embodiments, headset 100 provides an augmented reality view through which content may be displayed in the user's field of view. In embodiments, the content may be displayed to a user through a display positioned in the user's field of view, such as a light field display, liquid crystal display (LCD) an organic light-emitting diode (OLED) display or prism positioned in the user's field of view. In alternative embodiments, the content may be projected directly into the user's eye. For example, in embodiments, headset 100 may comprise a virtual retina display (VRD), which draws an image onto the user's retina using a light source, such as lasers or LEDs. In alternative embodiments, the display of headset 100 comprises a light source (such as LEDs, lasers, etc.) that projects light onto one or more waveguides in the lenses of headset 100. In embodiments, the waveguide(s) reflect the light into the user's eyes to display content to the user in a virtual view as is known to those skilled in the art.

One skilled in the art will recognize that there are a number of technologies for displaying content to a user in a virtual view that are currently being used, researched, and/or developed for AR/VR, that may be used with the present invention. This includes the display technologies found in existing AR headsets, including the Microsoft HoloLens, the Magic Leap One, the Meta 2, etc. This also includes display technologies found in existing VR headsets, including the Oculus Rift, the HTC Vive Pro, the Google Daydream View, etc.

In embodiments, headset 100 comprises one or more cameras 120. Cameras 120 may be used to capture images of the user's environment, which may be analyzed to provide relevant information to the user regarding the environment and/or detected objects in the user's field of view. In embodiments, headset 100 may comprise multiple cameras 120 that have different focal lengths, capture different perspectives of the user's field of view or are focused on different portions of the user's environment, including cameras that capture images outside the user's field of view (e.g., behind the user). In embodiments, images from multiple cameras 120 may be stitched together to represent a larger field of view. For example, multiple cameras may be needed to capture the entire field of view of a user. In such embodiments, images from the multiple cameras may be aligned using well-known stitching techniques to create an image that represents a field of view equal to or greater than that of the user. In embodiments, the headset 100 may also incorporate infrared or night vision cameras that may be used to provide useful information to a user in dark environments (e.g., at night).

In embodiments, headset 100 may also comprise one or more eye/gaze tracking cameras 120 that face toward the user and are used to track the user's eyes/gaze as is known in the art. In embodiments, the eye/gaze tracking camera(s) 120 capture images of the user's eyes, which may be analyzed to determine where the user is looking within the user's field of view and/or the virtual view provided by the headset 100. In embodiments, eye/gaze tracking may be performed using a neural network that is trained on a plurality of images of the user's eyes taken by an eye/gaze-tracking camera 120 with the ground truth for each of the respective images comprising a representation of where the user is looking. In embodiments, the ground truths may comprise a vector(s), coordinates in 2D or 3D space, etc. In embodiments, a captured image of the user's eye may be input to the trained neural network, which performs an inference and outputs data representing the user's gaze point. One skilled in the art will recognize that there are a number of ways to perform eye/gaze tracking that are well known in the art and fall within the scope of the present invention. For example, in embodiments, the user's gaze point may be estimated from the orientation of the AR/VR headset as is known to those skilled in the art. Other example eye/gaze tracking technologies include, but are not limited to, the technology found in Microsoft's HoloLens, the Magic Leap One AR headset, the HTC Vive Pro Eye VR headset and eye tracking technology from Imotions, Tobii and Pupil Labs. As discussed further herein, in embodiments, eye/gaze tracking may be used to improve the user's interaction with the headset 100.

In embodiments, headset 100 may support the detection of gestures from a user as an input mechanism for interacting with headset 100. In embodiments, one or more cameras 120 may be used to detect gestures performed by the user. For example, camera(s) 120 may continuously capture photos within the user's field of view at a set frame rate (e.g., 10, 30 or 60 frames per second). In embodiments, the captured images are analyzed to identify potential gestures formed by the user's hand(s). Example gestures may include static hand gestures, such as a fist, two fingers of the left hand pointing to the right, a thumbs up, etc. In embodiments, the gestures may comprise moving hand gestures that require analysis of a sequence of images captured by the camera. Example moving gestures include a pinch gesture that begins with an index and thumb separated by a distance, followed by reducing the distance between the user's index finger and thumb until the two meet. Another example of a moving gesture is a “blow up” or “explosion” gesture which starts with the user's hand forming a fist followed by opening the fist until all of the user's fingers (and thumb) are open (e.g., as if the user is indicating the number 5 by showing all their fingers and thumb).

In embodiments, gesture detection may be performed using a neural network that is trained on a plurality of images of people's hands forming the various gestures with the ground truths being the respective gesture (if any). Using the trained model, a captured image of the user's hand may be input into the neural network, which will output a probability that the user's hand is performing a respective gesture. If the probability is above a predetermined value, the respective gesture is detected. For moving gestures, once the start of the moving gesture is detected, a subsequent neural network or networks (e.g., a chain of neural networks) may look for other hand gesture positions that suggest the user is performing the gesture. For example, assuming a first neural network detects a user's finger and thumb separated by space, subsequent images of the user's hand may be input to a subsequent neural network or subsequent passes through the first neural network to determine if the space between the finger and thumb shrinks (or expands). One skilled in the art will recognize that there are a number of ways to perform gesture detection that are well known in the art and fall within the scope of the present invention.

In embodiments, headset 100 may comprise a variety of sensors 130 that can be used to provide the user with relevant information about the user's environment. Example sensors 130 include temperature sensors that measure the current temperature of the user's environment, barometers that measure barometric pressure, light detectors that detect the ambient light of the environment, etc. Such sensors 130 are well known to those skilled in the art.

In embodiments, headset 100 may comprise a microphone 140 that detects sound from the user's environment. In embodiments, sound detected by the microphone 140 is processed by headset 100 (e.g., via audio processing circuitry) to provide one or more features of the present invention. For example, in embodiments, headset 100 may support voice commands as an input mechanism for interacting with headset 100. One skilled in the art will recognize that there are a number of techniques for supporting voice commands that fall within the scope of the present invention.

FIG. 1B is a block diagram of various hardware components of an AR headset 100 according to embodiments of the invention. In embodiments, the hardware components may be coupled by wired (e.g. a bus) or wireless technologies that are well known to one skilled in the art. In embodiments, the various hardware components are found within the AR headset 100. In alternative embodiments, a portion of the hardware components may be implemented in a separate device, such as a smartphone or other external computing device that is coupled to the AR headset 100 using a wired or wireless connection (e.g., Wi-Fi, Bluetooth, LTE, 5G, etc.).

In embodiments, headset 100 comprises a memory 105, processing circuit 115, a wireless transceiver 125 a location services circuit 135, an audio processing circuit 145, an image processing circuit 155 and a display circuit 165. In embodiments, the various hardware components are coupled to a bus that facilitates communication between the hardware components as is well known in the art. In embodiments, memory 105 is a non-transitory computer readable medium that stores data relevant to the operation of the headset 100, including software applications, an operating system, user data, etc. In embodiments, memory 105 may be comprised of volatile (e.g., DRAM) and/or non-volatile memory (e.g., flash memory, a hard drive, etc.).

In embodiments, processing circuit 115 comprises one or more processors that control the operation of headset 100. In embodiments, the one or more processors execute one or more instructions of software stored in memory 115 to implement the various features of the present invention described herein. In embodiments, processing circuit 115 comprises one or more of a central processing unit (CPU), a graphics processing unit (GPU) and an application specific integrated circuit (ASIC). One skilled in the art will recognize that there are a number of CPUs, GPUs and ASICs that may be used in headset 100. Example CPUs include, but are not limited to, those provide by ARM (e.g., ARMv8-A-based CPUs), Intel (x86-based CPUs), AMD (x86-based CPUs) and others. Example GPUs include, but are not limited to, those from Intel, ARM (e.g. Mali-based GPUs), NVIDIA (e.g. Pascal or Maxwell based GPUs), AMD (e.g., Polaris-based GPUs) and others. Example ASICs include, but are not limited to, the Myriad Vision Processing Unit (VPU) from Intel, Volta-based processors from NVIDIA, Google's tensor processing units (TPU), image processing circuits, etc. In embodiments, one or more ASICs are included to execute one or more trained neural networks within headset 100. In embodiments, neural networks may be used to support a number of functions of headset 100, including gesture detection, voice commands, object identification, eye/gaze tracking, etc.

In embodiments, the processing circuit 115 may be integrated into the headset 100. In embodiments, processing circuit may be part of a separate device that is coupled to the headset 100 using a wired or wireless connection (e.g., Bluetooth, Wi-Fi, LTE, etc.). For example, the separate device may be a smartphone, one or more Internet servers, a laptop/desktop computer, or other computing devices that are known in the art. In alternative embodiments, processing circuit may be split between headset 100 and a separate device coupled to headset 100 using a wired or wireless connection. For example, headset 100 may comprise one or more CPUs to execute software locally on headset 100 and may rely on additional processing power from external devices (e.g., smartphones, servers, etc.) to supplement the processing power for headset 100.

In embodiments, headset 100 comprises a wireless transceiver 125. In embodiments, wireless transceiver 125 comprises a transmitter and a receiver for sending and receiving wireless signals (such as radio waves) according to a wireless standard, such as Bluetooth, Wi-Fi, LTE, 5G, etc as is well known in the art. One skilled in the art will recognize that the wireless transceiver 125 can be used to communicate data with external devices as is well known in the art.

In embodiments, headset 100 comprises a location services circuit 135 that determines a location of headset 100. For example, in embodiments, location services circuit 135 comprises a Global Positioning System (GPS) circuit that receives satellite signals and determines the position of the device as is known to those skilled in the art.

In embodiment, headset 100 comprises an audio processing circuit 145. In embodiments, audio processing circuit 145 is coupled to receive sound data detected by microphone 140. In embodiments, the audio processing circuit processes the data using techniques that are well known in the art. In embodiments, the audio processing circuit 145 may comprise a digital signal processor, such as TDA7590 from STMicroelecronics or the TMS320C5517 Fixed-Point Digital Signal Processor from Texas Instruments. In embodiments, data may be output from the audio processing circuit to one or more neural networks trained to identify words and/or utterances to assist in the recognition of voice commands as is well known in the art.

In embodiments, headset 100 comprises an image processing circuit 155. In embodiments, image processing circuit 155 receives image data from one or more cameras 120 of headset 100 and processes the image data as is well known in the art. In embodiments, the image processing circuit comprises one or more image signal processors (ISPs). Some example circuits that comprise image signal processors include, the OmniVision OV680, Qualcomm's Spectra 280 and 380 ISPs, ARM's Mali C-52 or C-32. In embodiments, image processing may include performing white balance, exposure compensation, compression, etc. In embodiments, the image data may be further processed by headset 100 to assist in the performance of a number of functions/features, including gesture detection, eye/gaze tracking, image analysis, etc. For example, the image processing circuit 155 may output image data to a neural network trained to identify specific objects (e.g., hand gestures) or trained to perform eye/gaze tracking as is known to those skilled in the art.

In embodiments, headset 100 comprises a display circuit 165. In embodiments, display circuit 165 receives data for display in a virtual view and processes the data according to the display technology used by by headset 100. For example, if the headset 100 uses more traditional display technologies, such as OLED or LCD displays, to provide the virtual view, the display circuit 165 comprises a display driver integrated circuit (IC) to process the data for the respective display as is well known in the art. In embodiments in which the headset 100 projects light from light emitting diodes (LED), lasers or other light sources into the user's eyes either directly or via reflection (e.g., via waveguides in lenses of the headset (e.g., Microsoft's Hololens, the Magic Leap One and the Avegant Video Headset)), the display circuit 165 comprises circuitry to process the data for display and output data that is used to control or alter the light from the respective light source. In embodiments, an example display circuit comprises the OmniVision OP02220 liquid crystal on silicon (LCOS) circuit. In embodiments, another example display circuit comprises digital light processing (DLP) chipsets from Texas Instruments (e.g., a DLPC2607 Display Controller with a DLP2000). Again, since there are a number of different existing (and yet to be developed) technologies that may be used in a headset to provide a virtual view, one skilled in the art will recognize that there are a variety of different display circuits that fall within the scope of the present invention and may be used to process the data for a respective display technology.

### AR/VR Documents

In embodiments, the present invention provides improved systems, devices, user interfaces and methods for reviewing and interacting with electronic documents in a virtual view, such as a mixed reality view, augmented reality (AR) view or virtual reality (VR) view provided by an AR/VR headset. The invention not only improves upon AR/VR technology and devices but also provides users with more efficient means for viewing and interacting with electronic documents as compared to existing technologies. In addition, the invention reduces physical clutter and or waste associated with viewing physical documents in conjunction with a computer screen. As discussed further herein, in embodiments, the present invention may also be used in mobile devices (e.g., smartphones and tablets) and applications running on traditional computing devices (e.g., laptop and desktop computers).

FIG. 2 is a representation of a virtual view (e.g., virtual reality view, mixed reality view, augmented reality view, etc.) 290 as seen through an AR/VR headset according to embodiments of the invention. In embodiments, view 290 comprises an electronic document 220 that is displayed in the user's field of view by the AR/VR headset (e.g., through a display or projection directed into the user's eyes as discussed previously). In embodiments, view 290 also comprises a desk 200 and computer 210 that are either displayed virtually in the case of VR or are real world objects that visible in the user's environment. In embodiments, electronic document 220 may be pinned to a particular location (e.g., anchor point) such that it appears to be floating in midair. In the example of FIG. 2, the electronic document 220 appears to be floating adjacent to (above in this case) the display screen of computer 210. In embodiments, this allows a user to quickly reference electronic document 220 while doing other tasks (such as drafting or reviewing a separate document) on computer 210. By positioning the virtual document adjacent to computer 210, the user can easily reference the electronic document 220 without taking up any room on the display screen of computer 210 and without having to switch back and forth between electronic documents in different windows displayed on computer 210. It also eliminates clutter on the user's desk 200 that would be introduced by a physical copy (e.g. printed copy) of document 220.

In embodiments, the user may scroll the electronic document 220 using a variety of techniques supported by the AR/VR headset. For example, in embodiments, the user can scroll electronic document 220 using voice commands (e.g. “scroll up”) and/or gestures that are detected and interpreted by the AR/VR headset as known to one skilled in the art. As another example, the user can scroll electronic document 220 using a traditional mouse or a touch screen device that interfaces with the AR/VR headset over a wired or wireless communication technology (e.g., Bluetooth, Wi-Fi, 3G, LTE, etc.). In embodiments, the touch screen device detects user touch events on the touch screen, such as a single tap, double tap, directional swipe, etc. In embodiments, the AR/VR headset uses the touch events to control the scrolling of an electronic document 220 in view 290. For example, data related to a swipe event on the touch screen device (such as the direction and speed of a swipe gesture) may be transmitted from the touch screen device to the AR/VR headset, which uses the data to determine a direction and magnitude to scroll the electronic document 220 displayed in the view 290. Example touchscreen devices that may interact with an AR/VR headset include, but are not limited to, smartphones, remote controls with touch screens (similar to the remote for Apple TVs) and/or stand alone controllers. As referenced previously, in embodiments, electronic document 220 may be scrolled using a traditional mouse that is coupled to the AR/VR headset via a wired or wireless connection.

In embodiments, the user's gaze may be used to scroll the document by detecting the user's gaze on a predetermined scroll region. For example, FIG. 2 comprises an up arrow 211 and down arrow 212 that are displayed in the virtual view 290 by the AR/VR headset. In embodiments, the user may view up arrow 211 or down arrow 212 to scroll the document. In alternative embodiments, a predetermined portion of the top and bottom of the tile that displays the electronic document (e.g., the top and bottom 10% of the tile respectively) may be up and down scroll regions, respectively. In embodiments, the scroll regions may be highlighted. For example, the predetermined top and bottom portions of the tile may be shaded with a different color to provide a visual indicator to the user of the scroll regions.

In embodiments, the AR/VR headset comprises one or more cameras that capture images of the user's eyes and uses the captured images to track the user's gaze as is known to one skilled in the art. In other words, the headset may use one or more captured images of the user's eye(s) to determine where the user is looking. In embodiments, responsive to the user fixing his/her gaze within a predefined scroll area (e.g., the scroll area enclosed by the circle around the respective arrow in FIG. 2) for a predetermined period of time, hardware and/or software executing on the AR/VR will scroll the electronic document 220 in the respective direction. In embodiments, the scroll region may be highlighted (e.g., via color change, increased prominence, etc.) in the virtual view 290 when the user's gaze is detected as being fixed on the scroll region to provide a visual feedback to the user that a scroll event is occurring or will occur.

In embodiments, the user's gaze may also be used to alter the prominence of the electronic document 220 within the view 290. For example, responsive to the AR/VR headset detecting that the user's gaze is not focused on electronic document 220, the headset may decrease the prominence of virtual document in the virtual view 290. For example, the AR/VR headset may increase the transparency of electronic document 220 (including the tile border), alter the color of a portion of the document 220 or alter the prominence (e.g., thickness) of lines or text of document 220 if the user is not focused on the document 220. In embodiments, the prominence of the electronic document 220 may continuously change over time. For example, the longer the AR/VR headset detects that the user's gaze has not focused on the electronic document 220, the headset may gradually increase the transparency associated with the document over time to make it less prominent. In embodiments, if the user's gaze has not focused on the electronic document 220 for a predetermined period of time, the AR/VR headset may remove the document from the virtual view 290 entirely.

In the example of FIG. 2, electronic document 220 is a representation of U.S. Pat. No. 10,000,000, which is presented in the user's field of view through an AR/VR headset. Patent documents typically comprise various sections, including text that describes the invention, figures that illustrate the invention and claims that determine the scope the invention. When reviewing a patent (or other document that has figures, text, tables, etc.), a user may want to quickly reference the figures and/or claims while reviewing the corresponding text that describes the invention. Currently, when reviewing an electronic patent document, such as a PDF version, on a computer screen, this often requires scrolling between non-sequential pages of the PDF. For example, the figures of a patent may be found on pages 2 through 10 of the PDF document, while the text corresponding to a figure on page 9 may be found on page 25 of the document. Scrolling between page 9 and 25 to compare the text with the associated figure is inefficient and takes up valuable user time.

In embodiments, the present invention overcomes limitations of the prior art by displaying different portions of an electronic document 220 in a tiled representation within the virtual view 290 (e.g., augmented reality, mixed reality or virtual reality view) provided by an AR/VR headset as discussed further herein. In embodiments, each tile may comprise a single page of the electronic document, a portion of the electronic document (such as an excerpt of text, a figure, or a table) or a plurality of pages from the electronic document. In embodiments, the invention provides a useful and efficient way for the user to quickly reference multiple portions of an electronic document at the same time and without taking up valuable screen space on the user's computer screen 210 or the physical space (e.g. due to a printed version of the document) on the user's desk 200.

FIG. 3 is a representation of a virtual view (e.g., virtual reality view, mixed reality view, augmented reality view, etc.) 390 as seen through an AR/VR headset that comprises three tiles 320, each comprising at least a portion of electronic document 220 (here U.S. Pat. No. 10,000,000), tiled horizontally within the virtual view 390 according to embodiments of the invention. In the example of FIG. 3, tile 320A is comprised of one or more figures of document 220, tile 320B is comprised of the entirety of document 220 and tile 320C is comprised of one or more of the claims of document 220. In embodiments, each tile 320 may comprise consecutive pages of a document. For example, patent documents typically provide the figures consecutively within a document. However, in embodiments, each tile 320 may comprise a collection of related pages or portions of a document 220 that are not sequential within electronic document 220. For example, in a document 220 in which the figures are dispersed throughout the document, the figures may be organized such that the dispersed figures are collated such that they can be displayed and scrolled sequentially within a given tile 320.

In embodiments, one of the plurality of tiles 320 is highlighted to indicate that it is the active tile. In the FIG. 3 example, tile 320A is highlighted via a border that is darker and thicker than the other documents. As another example, tile 320A may be highlighted by increasing the transparency of the other tiles 320B and 320C, which reduces their prominence with respect to the highlighted tile 320A. As yet another example, the highlighted tile 320A may be displayed with different colors than the other tiles 320. One skilled in the art will recognize that there are a number of ways to highlight an active tile that fall within the scope of the present invention.

In embodiments, user interactions that are detected by the AR/VR headset will only impact the active tile 320. For example, any gestures, eye/gaze tracking, voice commands, and/or inputs from a touch screen controller received from the user will control the active tile (e.g., 320A), not the inactive tiles (e.g., 320B and 320C). As an example, user interactions that are intended to cause a scrolling event will only impact the active tile (e.g., 320A), not the inactive tiles (e.g., 320B and 320C).

In embodiments, the user may switch the active tile 320 through various interactions supported by the AR/VR headset. For example, in embodiments, the user may switch the active tile using voice commands, gestures and/or inputs from a touch screen controller using techniques that are known to one skilled in the art. In embodiments, the user may switch the active tile by focusing his/her gaze on one of the inactive tiles 320. Once the AR/VR headset detects the user's gaze (e.g., through software executing on the AR/VR headset) in an inactive tile 320 for a predetermined period of time, that inactive tile 320 will become the active, highlighted tile 320 and the previously active tile 320 will be de-highlighted.

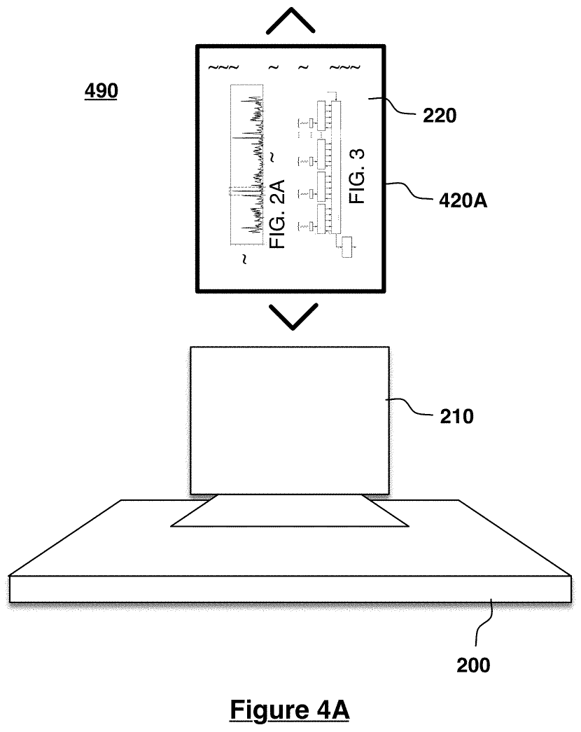

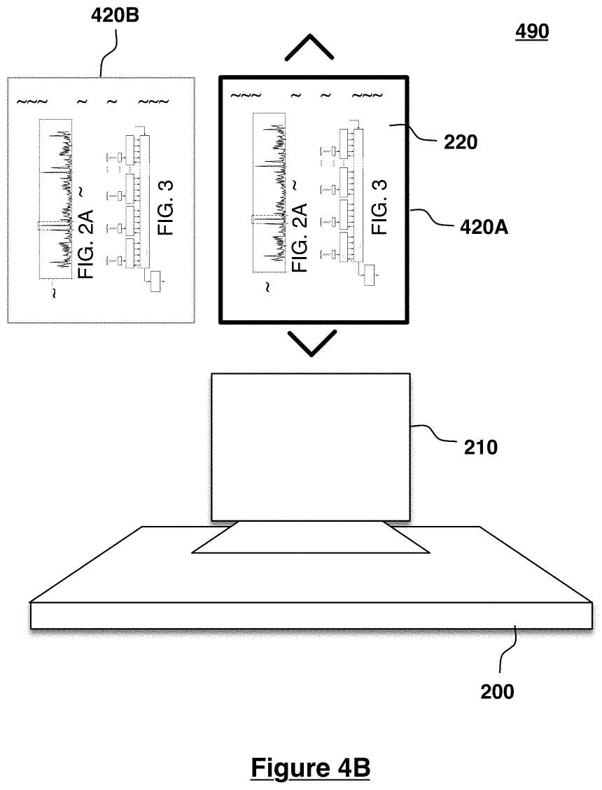

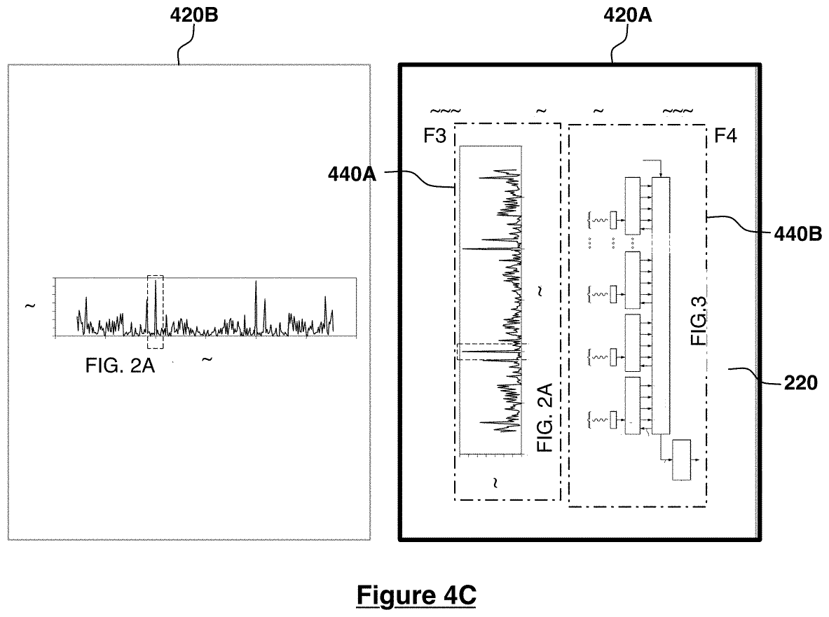

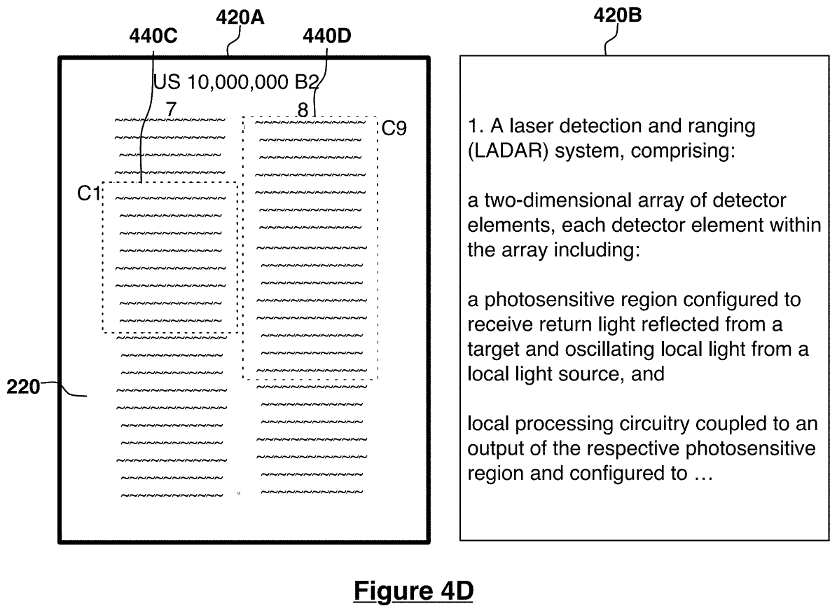

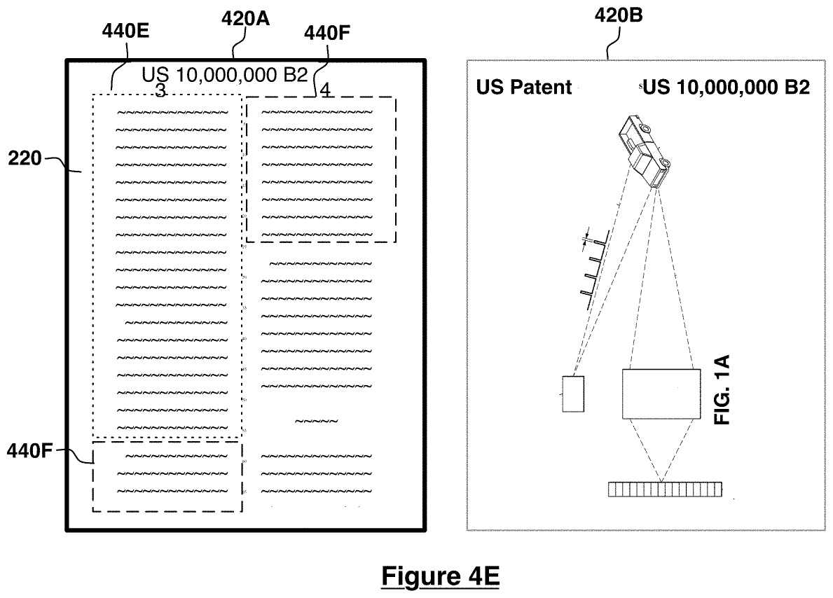

In embodiments, the user can determine which portion of an electronic document 220 to launch as a new tile. For example, FIG. 4A shows a page of electronic document 220 displayed in a single tile 420A within a virtual view 490 according to embodiments of the invention. In embodiments, a user may create/launch a new tile 420 that comprises this portion of the electronic document 220 through one or more interactions detectable by the AR/VR headset. These interactions (also referred to as trigger events) include, but are not limited to, voice commands, eye/gaze tracking events, gestures and/or inputs from a controller.

For example, in embodiments, the user can use a voice command, such as “create tile left,” which the causes software and/or hardware executing on the AR/VR headset to create a new tile 420B to the left of the current tile 420A as shown in FIG. 4B. In embodiments, the newly created tile 420B may only comprise the current page (or content) of electronic document 220 displayed in originating tile 420A. In alternative embodiments, the newly created tile 420B may comprise multiple pages or portions of the electronic document 220 displayed in the originating tile. For example, if the user creates a new tile 420B from a figure of the electronic document 220 in originating tile 420A, the new tile 420B may comprise some or all of the figures from the electronic document 220 in the new tile 420B that the user can scroll through using the various techniques described herein. In yet another embodiment, when a new tile 420B is created, it may comprise a complete copy of electronic document 220 displayed in originating tile 420A that may be scrolled independently.

FIG. 4C shows a close-up view of tiles 420A and 420B according to embodiments of the invention, wherein portions of the electronic document 220 displayed in tile 420A are delineated with dashed lines 440A and 440B. For example, dashed lines 440A outline FIG. 2A and dashed lines 440B outline FIG. 3 in electronic document 220. In embodiments, the delineated portions may also have identifiers that are associated with the respective delineated portions. For example, dashed lines 440A may be associated with identifier F3 and dashed lines 440B may be associated with identifier F4. In embodiments, the user can use voice commands to launch a new tile 420B for the delineated portion of electronic document 220 in tile 420A. For example, responsive to the voice command “create tile left from F3,” a new tile 420B comprising the associated delineated content is created to the left of the current tile 420A as shown in FIG. 4C.

In embodiments, a combination of gestures, voice commands and/or interactions with a touchscreen device may be used in combination with eye/gaze tracking to create a new tile 420. For example, if the user performs a predetermined gesture, such as forming a “C” with the user's left hand, the AR/VR headset and/or application will recognize the gesture as an intention to create a new tile 420B to the left of originating tile 420A. In embodiments, the content of the new tile 420B may depend on the user's gaze point within the electronic document 220 displayed in the originating tile 420A. For example, responsive to the AR/VR headset detecting that the user's gaze is focused within the area delineated by dashed lines 440A when the user performs a “create tile” gesture, the new tile 420B is created with the content associated with dashed lines 440A, namely FIG. 2A in this example. As another example, responsive to the AR/VR headset detecting that the user's gaze is focused within the area delineated by dashed lines 440A when the user utters a “create tile” voice command, the new tile 420B is created with the content associated with dashed lines 440A, namely FIG. 2A in this example.

FIG. 4D is another close-up representation of an electronic document 220 within tile 420A according to embodiments of the invention. In this example, portions of the text of the electronic document 220 are delineated by dashed lines 440C and 440D, respectively. As discussed previously, responsive to a trigger event, a new tile 420 may be created with the content associated with the respective dashed lines. In the example of FIG. 4D, the new tile 420B, which was created to the right of tile 420A, comprises content associated with dashed lines 440C, which in this example is the text for claim 1 of the U.S. Pat. No. 10,000,000 patent.

In embodiments, different regions of an electronic document 220 may be associated with a respective figure, table, related text or other information that may be displayed to the user by the AR/VR headset. In embodiments, the related content may be displayed in a separate tile 420 automatically when the user's gaze falls within a respective region for a predetermined period of time. Alternatively, the related content may be displayed in a separate tile 420 responsive to other trigger events (e.g., voice command, gesture or input from a controller) that are detected while the AR/VR headset detects the user's gaze in a respective region.

As an example, FIG. 4E is a representation of a document 220 viewed through an AR/VR headset in tile 420A according to embodiments of the invention. In this example, document 220 is divided into regions 440E and 440F as represented by the dashed lines separating the regions. In this example, region 440E is associated with FIG. 1A of document 220 and region 440F is associated with FIG. 1B of document 220. In embodiments, as represented in FIG. 4E, responsive to the AR/VR headset detecting the user's gaze (e.g., through eye/gaze tracking software on the AR/VR headset) within region 440E of the document 220 displayed in tile 420A, the AR/VR headset may automatically display FIG. 1A to the user in a separate tile 420B. As the user continues to read the document 220 in tile 420A, the AR/VR headset will detect that the user's gaze transitions from region 440E to region 440F. In embodiments, responsive to the AR/VR headset detecting (e.g., through software) the user's gaze moving to the new region 440F, the content of tile 420B is updated to display second content which is associated with region 440F. In the example of FIG. 4E, FIG. 1A in tile 420B would be replaced with FIG. 1B from U.S. Pat. No. 10,000,000. Again, it is worth noting that in some embodiments, the content associated with a region (e.g., 440E or 440F) may be displayed responsive to a trigger event, rather than occurring automatically based on the user's gaze.

In embodiments, the software and/or hardware of the AR/VR headset must detect the user's gaze within a particular region of document 220 for a predetermined period of time before the content (e.g., figure) associated with the region is displayed to the user in a separate tile. In embodiments, this provides a better user experience, as different content is not flickering on the screen as the user quickly scans a document. In addition, this prevents the content from changing as the user scans across the page from the region of a page to the associated content displayed in an adjacent tile. For example, the user's gaze may briefly fall on a different region of the page when the user's eyes scan from the region to the associated content displayed in a separate tile 420.

While many of the embodiments disclosed thus far display content from the existing tile in the newly created tile, in embodiments, the user may specify the content to associate with a particular portion of the content displayed in a tile. For example, the user may choose to associate a text document or a URL to a newly created tile, thus associating the chosen content with the content displayed in the original tile.

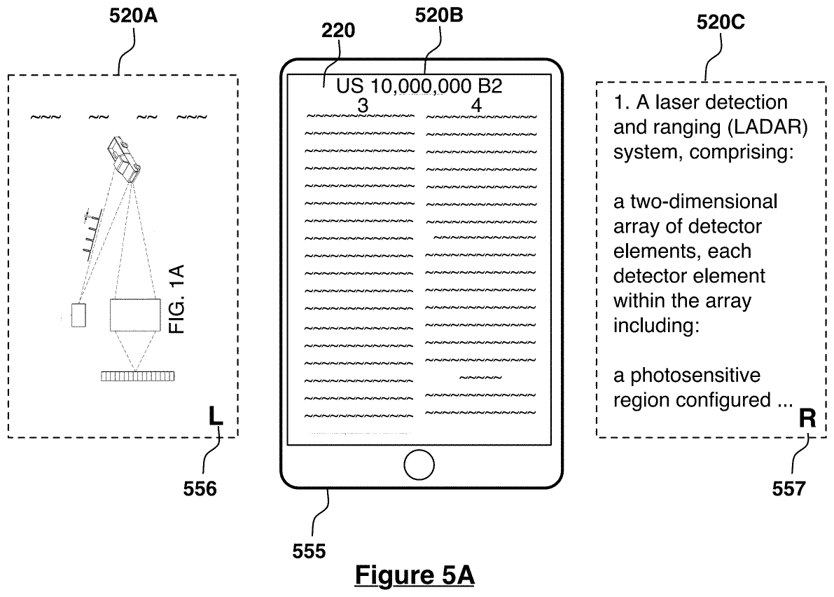

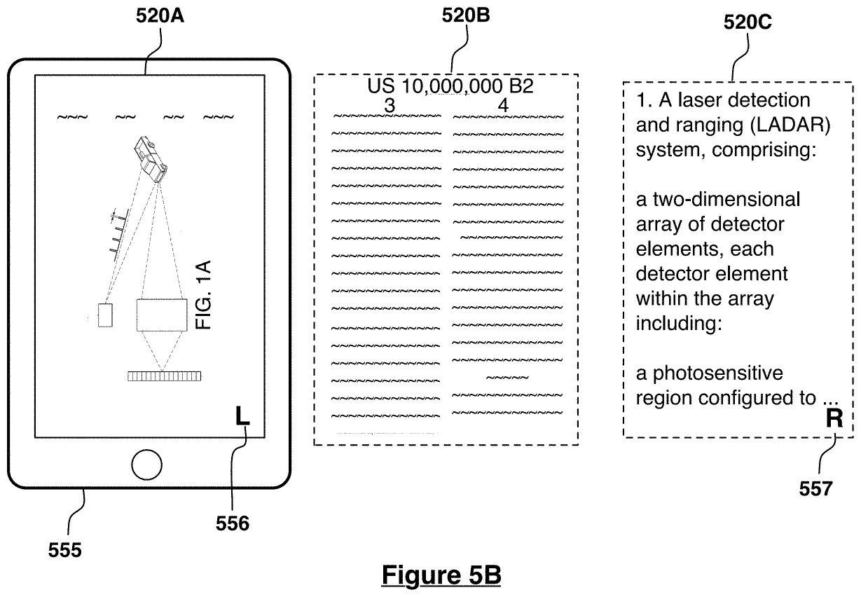

While the above embodiments disclose improved techniques for viewing and interacting with documents in an AR/VR environment, the present invention is also useful on a tablet computer, application window of a computer display or other devices. For example, FIG. 5A is a representation of an electronic document 220 displayed in a software application executing on a tablet computer 555 according to embodiments. In embodiments, the application is comprised of instructions that are stored in a non-transitory readable medium on the tablet computer 555 as is well known in the art. In this example, tile 520B, comprising document 220 is displayed on tablet 555 while virtual representations of tiles 520A and 520C are shown on each side of tablet 555. As discussed above, each virtual tile 520A and 520C may be a figure/table, a single page of a document, a collection of pages from a document (e.g., all the figures of the document 220), or a complete copy of a document. In embodiments, the user can swipe up or down on the touchscreen of tablet 555 to scroll up or down a page of document 220 in tile 520B as is well known in the art.

In embodiments, the user can perform a special swipe gesture on the touchscreen of the tablet 555 to cause a virtual tile (e.g., 520A or 520C) to be displayed on tablet 555. For example, responsive to a two finger swipe gesture from left to right on the touchscreen display of tablet 555, the application replaces tile 520B with tile 520A on the display of tablet 555 as illustrated in FIG. 5B. A subsequent two finger swipe gesture on the touchscreen display of the tablet 555 from right to left causes the application to replace tile 520A with tile 520B on the touchscreen display of tablet 555. A second two finger swipe on the touchscreen of tablet 555 from right to left causes the application to replace tile 520B with tile 520C on the touchscreen display of tablet 555. In embodiments, one or more of the tiles 520 may comprise a label that is displayed on tablet 555 to indicate which tile 520 is currently being displayed. For example, in the embodiment of FIG. 5A, tile 520A has an “L” label 556 and tile 520C has an “R” label, representing “left” and “right,” respectively.

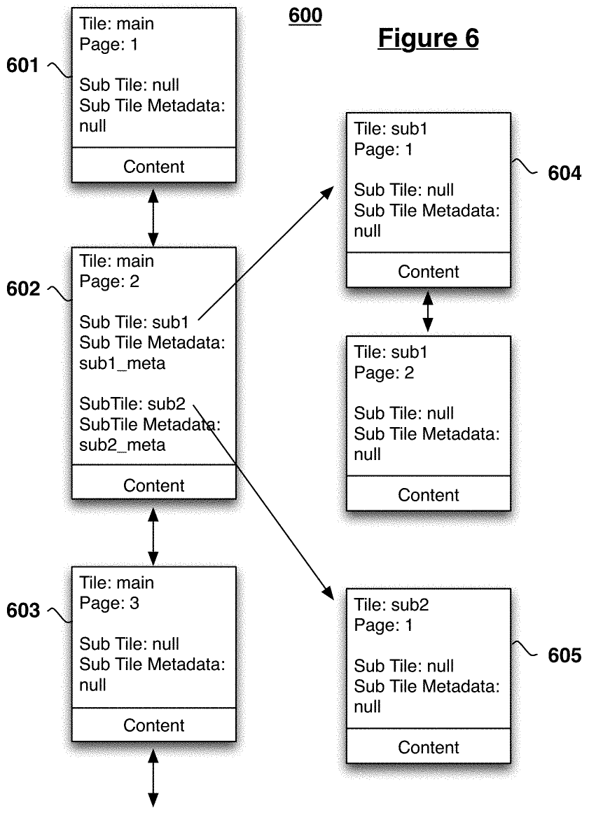

In embodiments, the present invention may be implemented as a two-dimensional electronic document format that comprises a data structure that stores information regarding the content that may be displayed in various tiles that branch from a main tile. FIG. 6 is an example data structure according to embodiments of the invention. In this example format, the contents are organized into a tree structure 600. The root node 601 comprises the initial content (e.g., page of a document) that will be displayed to a user in a tile. In embodiments, each node comprises metadata that identifies the tile, the page of the document, a list of sub-tiles (including metadata for each sub-tile) and a pointer to the content or the content itself (e.g., the page) that will be displayed.

In embodiments, as a user navigates between pages of a tile (e.g., the main tile), the application traverses the nodes of the tree structure 600 to determine the appropriate content to display. For example, if the user navigates from page 1 of the main tile to page 2 of the main tile, the application will traverse from node 601 to node 602 and display the content associated with node 602.

In the example of FIG. 6, node 602 comprises two sub-tile nodes, node 604 (labeled sub 1) and node 605 (labeled sub2). In embodiments, the application may use the sub-tile information to display additional content to the user in a separate tile as discussed previously. In embodiments, the sub-tile metadata comprises information about the display of the respective sub-tile. For example, the sub-tile metadata may include information about where the sub-tile should be displayed (e.g., to the left or right of the main tile). In embodiments, the metadata may also indicate the display status of the tile. For example, the status may indicate that the sub-tile should always be displayed when working in an AR environment. Alternatively, the status may indicate that the sub-tile should be displayed responsive to a trigger event (e.g., swipe gesture, voice command, a predetermined duration of a user's gaze, etc.). In embodiments, the status may instruct the application to display the sub-tile when the user's gaze falls within a specified region of the document (for example, as described with respect to FIG. 4E). In such cases, the sub-tile metadata may comprise information defining one or more bounding boxes that define the region of the electronic document for which the sub-tile should be displayed if the user's gaze falls in that region.

It is worth noting that the invention is not limited to the data structure implementation described above. In fact, many of the embodiments described herein may be implemented by software on an AR/VR headset for electronic documents of a variety of formats (e.g., PDF, Word, etc.), without modification to those formats. As an example, software on the AR/VR headset can perform the embodiments described with respect to FIG. 4B for any electronic document that may be displayed by the AR/VR headset. In embodiments, a container format can be used that maps content (e.g. pages of an electronic document) to one or more sub-tiles. Thus, one skilled in the art will recognize that there are a number of ways to implement the present invention, all of which fall within the scope of the invention.

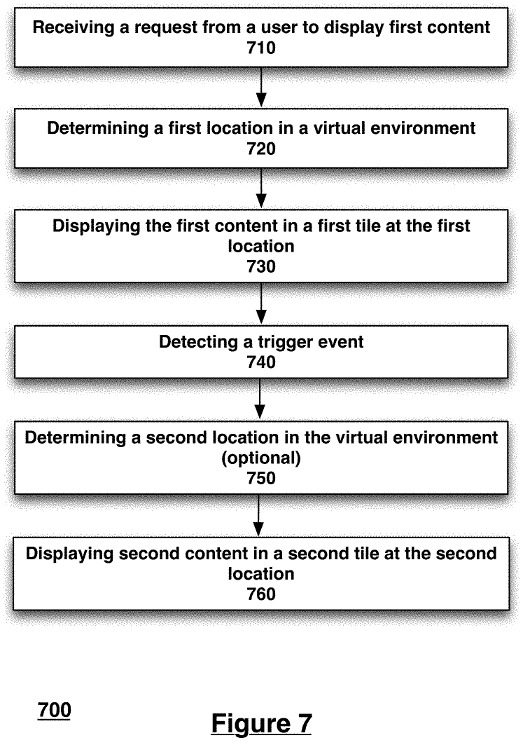

FIG. 7 is a flowchart of a method 700 for displaying multiple tiles in a virtual view according to embodiments of the invention. Flowchart 700 is intended to broadly capture multiple embodiments of the invention discussed throughout the specification. As such, one or more of the steps in the method 700 may be optional depending on the embodiment. In embodiments, method 700 is implemented in hardware and/or software executed by a processing circuit associated with an AR/VR headset as discussed previously. For example, a software implementation may be stored in a non-transitory computer readable medium, such as a memory, of the AR/VR headset. In embodiments, the software may be executed on a CPU, GPU, ASIC or combinations thereof that are part of, or coupled to, the AR/VR headset.

In embodiments, an AR/VR headset receives a request 710 from a user of the headset to display first content (e.g., an electronic document). In embodiments, the request may comprise a voice command to display a document, a request through a menu displayed to the user by the AR/VR headset, input from a touch screen controller or other input method described in the specification or that is known to one skilled in the art.

In embodiments, the AR/VR headset determines 720 a first location in a virtual environment at which the first content will be displayed. In embodiments, the location may be an anchor point in a virtual view (e.g., augmented reality view or virtual reality view) as is known in the art. In embodiments, the location may be determined based on input from the user. In alternative embodiments, the AR/VR headset may determine the location without input from the user. For example, the location may be an open space within the virtual view that is identified by the headset or a fixed distance in front of the user at the time of the request.

In embodiments, the AR/VR headset displays 730 the first content (e.g., electronic document) in a first tile at the first location. In embodiments, a tile displayed in a virtual view is a graphical interface container, similar to a window in a computer system that displays content. In embodiments, the first location is an anchor point in a virtual environment (e.g., augmented reality, mixed reality or virtual reality environment) as is well known in the art. Referring to the embodiments of FIG. 3 as an example, electronic document 220 is displayed in tile 320B at a first location (e.g. anchor point) floating above computer 210. In embodiments, the tile remains fixed at that location. However, in alternative embodiments, the tile may rotate around an x and/or y-axis as the user moves throughout the environment such that the document displayed in the tile always faces the user.

In embodiments, the AR/VR headset detects 740 a trigger event. In embodiments, the trigger event comprises a voice command, gesture, eye/gaze tracking event or other input (or combinations thereof) that represents a request to display second content (e.g., a portion of the electronic document displayed in the first tile) in a second tile. Numerous trigger events that result in the display of content in a separate tile have been disclosed throughout the specification. Referring to the embodiments of FIG. 4E as an example, FIG. 1A from the U.S. Pat. No. 10,000,000 patent may be displayed in a second tile responsive to software and/or hardware executing on the AR/VR headset detecting the user's gaze within region 440E of the first tile 420A for a predetermined period of time. As another example, the trigger event may be a voice command such as “create tile left” as discussed with respect to the embodiments in FIG. 4A.

In embodiments, the AR/VR headset determines 750 a second location (e.g., anchor point) in the virtual environment. In embodiments, the second location is selected relative to the first location. For example, the second location may be selected such that the second tile may be displayed adjacent to the first tile. As noted in the flowchart 700, this step is optional in some embodiments. For example, if the second tile in which the second content is to be displayed is already positioned in the virtual view, this step is not necessary and the method proceeds directly to displaying 760 the second content in the second tile.

In embodiments, the AR/VR headset displays 760 second content in a second tile at the second location. Referring to the embodiments of FIG. 4E as an example, tile 420B is displayed at a location adjacent to tile 420A in a virtual environment. In embodiments, the second tile is positioned to display the second content (e.g. a portion of the document displayed in the first tile) associated with the trigger event. As discussed previously, in embodiments, the second content may comprise a portion of the electronic document displayed in the first tile. For example, referring to the embodiments of FIG. 4E, the second content displayed in the second tile 420B comprises FIG. 1A from the U.S. Pat. No. 10,000,000 patent. In alternative embodiments, the second content displayed in the second tile may comprise content associated with a region of an electronic document displayed in a first tile on which the user's gaze is currently focused. For example, see the embodiments discussed with respect to FIGS. 4C, 4D and 4E.

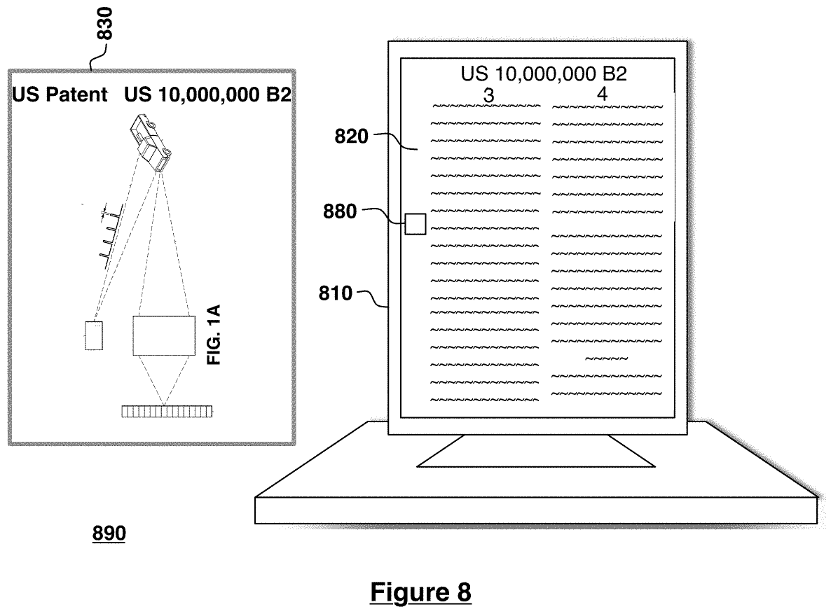

In embodiments, supplemental content associated with first content displayed on an external computing device may displayed in one or more tiles provided by an AR/VR headset in a virtual view. FIG. 8 is a representation of a virtual view (e.g., virtual reality view, mixed reality view, augmented reality view, etc.) 890 as seen through an AR/VR headset according to embodiments of the invention. In FIG. 8, an electronic document 820 is displayed on a computing device 810 that is within the user's field of view. In virtual reality environments, computing device 810 may be virtual, while in augmented reality environments, computing device 810 may be a physical computer in the user's environment. FIG. 8 also comprises a virtual tile 830 that is displayed adjacent to computing device 810 by an AR/VR headset in the virtual view 890.

In the example of FIG. 8, a portion (e.g., a page) of an electronic document (here a PDF version of U.S. Pat. No. 10,000,000) is displayed on the screen of computer 810. In this example, virtual tile 830 displays supplemental content (e.g., FIG. 1A from U.S. Pat. No. 10,000,000) that is associated with the first content displayed on computing device 810. In embodiments, a marker 880 displayed with electronic document 820 on computing device 810 is used to indicate to an AR/VR headset that supplemental content is available for display as discussed further herein. In embodiments, the marker 880 may comprise a QR code, bar code or a specific image, pattern or text.

In alternative embodiments, a user may initiate the display of the supplemental content by the AR/VR headset through a user action input through computer 810. Example interactions may comprise a series of keystrokes on a keyboard coupled to computer 810, a selection from a user interface on computer 810 or by clicking the marker 880 on the screen of computer 810 using a mouse or touchpad coupled to computer 810 as is well known in the art. In embodiments, responsive to detecting the user action on computer 810, the computer 810 may transmit (e.g. via wired or wireless transmission) a message to the AR/VR headset of the user requesting that the AR/VR headset display the supplemental content in the virtual view provided by the AR/VR headset. In embodiments, the message may comprise the content to display. In alternative embodiments, the message may comprise a universal resource locator (URL) that points to the supplemental content. In embodiments, the AR/VR headset accesses the supplemental content and displays it in one or more virtual tiles within the virtual view provided by the AR/VR headset.

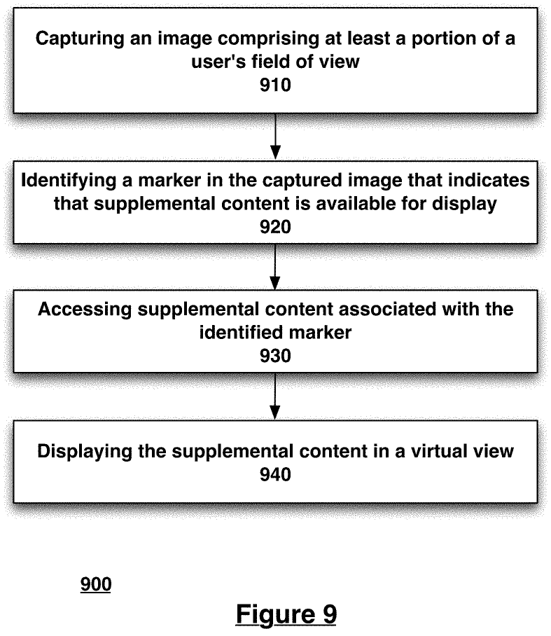

FIG. 9 is a flowchart of a method 900 for accessing and displaying supplemental content in a virtual view according to embodiments of the invention. In embodiments, a camera of an AR/VR headset captures 910 an image comprising at least a portion of the user's field of view. As discussed previously, the field of view of the camera may capture a wider field of view than the user's field of view or a narrower field of view than the user's field of view.

In embodiments, a marker is identified 920 within the captured image that indicates that supplemental content is available for display in a virtual view presented by the AR/VR headset. In embodiments, a marker comprises a QR code, bar code, a specific image, pattern or text. In embodiments, the marker is displayed as part of an electronic document displayed on a computer screen within the user's field of view. In embodiments, the captured image is analyzed to identify one or more markers. For example, in embodiments, the captured image is input to a trained machine learning algorithm, such as a neural network trained to detect particular markers (e.g., particular QR codes, bar codes, text, images or other markers).

In embodiments, supplemental content associated with the identified marker is accessed 930. In embodiments, responsive to detecting a particular marker, the content associated with that marker is determined. For example, in embodiments, a lookup table may be referenced that associates a detected marker with its supplemental content. In an alternative embodiment, the AR/VR headset may send a request/query to a computing device that is displaying the marker requesting the content associated with the marker. One skilled in the art will recognize that there are a number of ways to access the content associated with a marker.

In embodiments, the AR/VR headset displays 940 the supplemental content in the virtual view provided by the AR/VR headset. For example, in embodiments, the AR/VR headset may display the supplemental content in one or more virtual tiles positioned relative to the computing device that is displaying the marker. Returning to FIG. 8 as an example, the supplemental content is displayed in a virtual tile 830 that is part of the virtual view provided by an AR/VR headset.

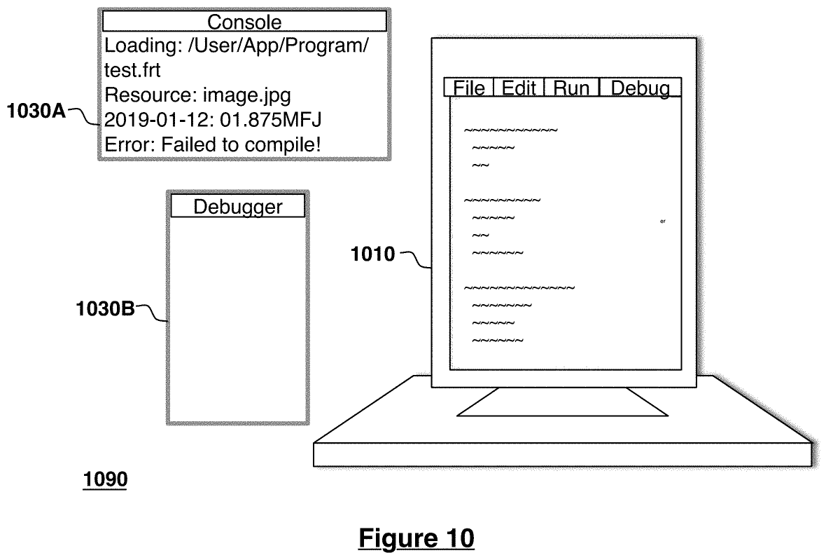

While many of the embodiments described above have been described with respect to viewing electronic documents, one skilled in the art will recognize that the invention is not limited to viewing electronic documents. In embodiments, the present invention may be used to display supplemental content in one or more virtual tiles for a variety of software applications that execute in computing environments. For example, FIG. 10 represents a virtual view 1090 provided by an AR/VR headset according to embodiments of the invention. The example view 1090 in FIG. 10 shows a software development environment comprising an integrated development environment (IDE) application. In the example of FIG. 10, the user is viewing a source code editor on the screen of computer 1010. In embodiments, supplemental content for the IDE application is displayed in virtual tiles 1030A and 1030B that are displayed adjacent to computer 1010 as part of the virtual view 1090 presented by an AR/VR headset. In the example of FIG. 10, tile 1030A displays console information that typically takes up a portion of the IDE application interface on the screen of computer 1010. Similarly tile 1030B displays debugging information that typically takes up part of the IDE application interface. Moving this supplemental information to one or more virtual tiles frees up screen space on the screen of computer 1010 without requiring additional monitors. In embodiments, the user can initiate the display of the supplemental content through a user interaction on computer 1010 as described previously.

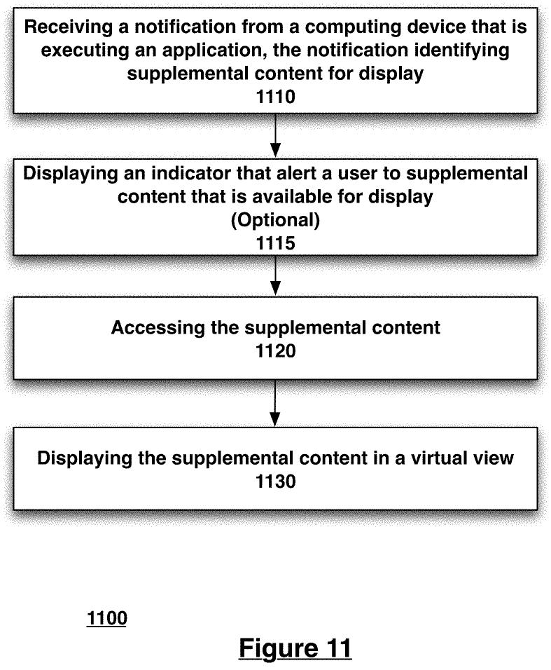

In embodiments, a software application executing on a computing device has supplemental content that may be displayed in a virtual view provided by an AR/VR headset. FIG. 11 is a flowchart of a method 1100 for displaying supplemental content according to embodiments of the invention. In embodiments, an AR/VR headset receives 1110 a notification from a computing device executing a software application. In embodiments, the notification may be transmitted from the computing device to the AR/VR headset via wired or wireless communication as is well known in the art. In embodiments the notification identifies supplemental content for display in an AR/VR headset. In embodiments, the notification may include the content for display. For example, in the IDE application example discussed above with respect to FIG. 10, the IDE application may stream console and/or debugging related data to an AR/VR headset for display in one or more tiles displayed in a virtual view provided by the AR/VR headset. In alternative embodiments, the notification may simply indicate that such supplemental content is available for access by the AR/VR headset. In embodiments, the notification may provide information regarding how to access the supplemental content (e.g., a URL to the location of the supplemental content).

In embodiments, an indicator is displayed 1115 in the virtual view by the AR/VR headset to alert the user to supplemental content that is available for display. For example, the AR/VR headset may display an image, text, etc. in the virtual view that indicates to the user the type of supplemental content that is available for display. In embodiments, the indicator may also instruct the user how to enable the display of the supplemental content. For example, the indicator may include a trigger phrase, such as “display console,” that the user may speak to request access to the supplemental content. In embodiments, responsive to a trigger event by the user requesting access to the supplemental content, the AR/VR headset initiates the access as discussed further herein. As noted in the flowchart, this step is optional and may be omitted in some embodiments.

In embodiments, the supplemental content is accessed 1120 by the AR/VR headset. In embodiments in which the notification comprises the content, accessing may simply comprise extracting the data from the notification. In embodiments in which the notification simply indicates that the supplemental content is available, the AR/VR headset may access the data by sending a request for the supplemental content to the computing device or other device (e.g., a server located on a network) that stores the data. In embodiments, it may be necessary to associate the supplemental content with a particular user for security reasons so that the content is only available to that user and not other users in the vicinity of the computing device. One skilled in the art will recognize that there are a number of techniques, including encryption, to limit access to the supplemental content to a particular user that fall within the scope of the present invention.

In embodiments, the supplemental content is displayed 1130 in a virtual view provided by the AR/VR headset. In embodiments, software and/or hardware executing on the AR/VR headset displays the accessed content in one or more virtual tiles that are displayed in the virtual view provided by the AR/VR headset as discussed previously.

In embodiments, a set of tiles may be grouped together as a project so that the user can easily switch between projects and thus the respective tiles displayed in the virtual view of the AR/VR headset. In embodiments, a project may also be saved to memory so that a user can retrieve it at a later time. For example, in embodiments, the user may group tiles 320A, 320B and 320C of FIG. 3 as a project entitled “work.” The user may group a second set of separately displayed tiles that relate to content for a user's hobby as a project entitled “fun.” In embodiments, the user may alter the virtual view displayed by the AR/VR headset by simply switching between projects. In embodiments, responsive to the voice command “display project work,” the AR/VR headset may display tiles 320A, 320B and 320C in the virtual view. Similarly, responsive to a second voice command “display project fun,” the AR/VR headset may remove tiles 320A, 320B and 320C from the virtual view and display the set of tiles associated with the user's hobby in the virtual view. This allows the user to easily access different collections of tiles at different times without cluttering the virtual view with all of the tiles at once. As mentioned previously, this also allows the user to save the state of a set of tiles displayed in a virtual view and return to that state at a later time.

One skilled in the art will recognize that there are a number of applications and use cases that can utilize tiles and the novel embodiments described herein. The various embodiments described herein are meant to be exemplary and are not intended to limit the present invention.

### Enhanced AR View

In embodiments, the present invention also provides improved systems, apparatuses, user interfaces and methods for enhancing a user's vision through a virtual view displayed to the user through an AR/VR headset as described further herein. This includes improved techniques for displaying a magnified portion of the user's field of view in a virtual view provided by the AR/VR headset. The invention also provides users with features not found in current AR/VR devices.

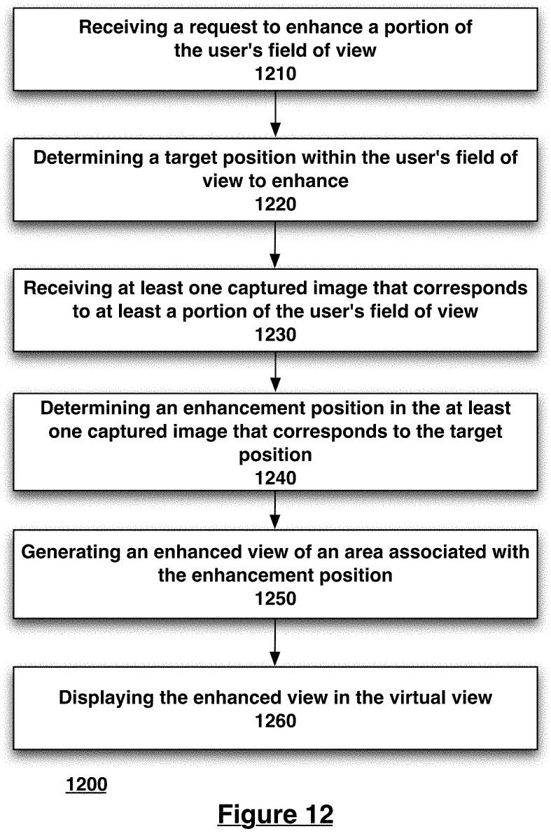

FIG. 12 is a flowchart of a method 1200 for enhancing a user's vision according to embodiments of the invention. In embodiments, method 1200 is implemented in hardware or software executed on a processing circuit associated with an AR/VR headset as discussed previously. For example, a software implementation may be stored in a non-transitory computer readable medium, such as a memory, of the AR/VR headset. In embodiments, the software is executed by a CPU, GPU, ASIC or combinations thereof located within or coupled to the AR/VR headset.

In embodiments, a request is received 1210 to enhance (e.g., magnify) a portion of the user's field of view. In embodiments, the request may be initiated in a variety of ways that are supported by an AR/VR headset. For example, in embodiments, a user may initiate a request through a voice command, such as “magnify view.” In embodiments, a user may initiate a request through one or more gestures. For example, the detection of a closed fist followed by the detection of an opening of the fist (e.g. a “blow up” gesture), may be associated with a request to magnify a portion of the user's field of view. In embodiments, the user may initiate a request using one or more buttons or other controls on a controller (e.g., touchscreen smartphone, Apple TV type remote controller, etc.) that is coupled to the AR/VR headset through a wired or wireless connection. In embodiments, the user may initiate a request through a user interface provided by the AR/VR headset.

In embodiments, a target position within the user's filed of view to enhance (e.g. magnify) is determined 1220. In embodiments, eye/gaze tracking is used to determine a gaze point (e.g., an approximation of where the user is looking) within the user's field of view. In embodiments, the gaze point is the target position. In alternative embodiments, a predetermined area around the determined gaze point is the target position to magnify. In embodiments, the gaze point may be represented as a vector. One skilled in the art will recognize that there are a number of eye/gaze tracking techniques that are known in the art that fall within the scope of the present invention. Example eye-tracking technologies include, but are not limited to, eye/gaze tracking technology found in the Microsoft HoloLens, the Magic Leap One headset, the HTC Vive Pro Eye VR headset and eye tracking technology from Imotions, Tobii and Pupil Labs.

In embodiments, the target position may be input through one or more controllers and a cursor. For example, some AR/VR headsets are capable of displaying a cursor in the virtual view displayed in the user's filed of view via one or more displays of the headset. In embodiments, the user may move the cursor within the augmented reality view using one or more controllers (e.g., touchscreen, joy sticks, hand tracking devices, etc.) that are well known in the art. In embodiments, the position of the cursor can be used to determine the target position to enhance. In embodiments, a voice command, gesture, button click from a controller or other user interaction may be used to set the target position and initiate the enhancement.

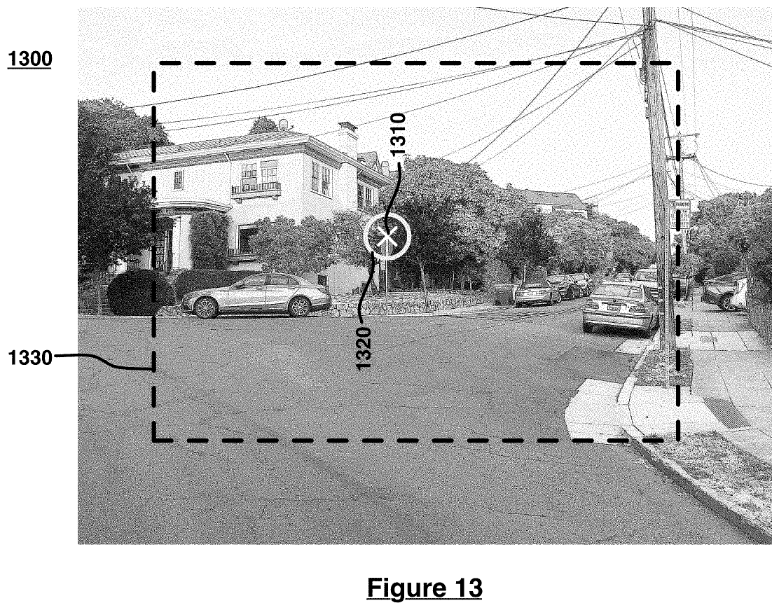

FIG. 13 is a representation of a virtual view (e.g., mixed reality or augmented reality) 1300 as seen through an AR/VR headset according to embodiments of the invention. In embodiments, the center of the crosshair 1310 represents a detected gaze point or cursor position in the view. As discussed previously, in embodiments, the position of crosshairs 1310 may be determined through eye/gaze tracking or through the manipulation of a cursor displayed in through the AR/VR headset by one or more controllers. As discussed previously, in embodiments, the position of the crosshair 1310 represents the target position. In alternative embodiments, the target position is the area within circle 1320 that is centered on crosshair 1310.

In embodiments, at least one captured image that corresponds with at least a portion of the user's field of view is received 1230 from one or more cameras. In embodiments, an image is captured by a forward facing camera on the AR/VR headset that captures at least a portion of the field of view of the user. It should be noted that, depending on the focal length of the lens of the camera, the field of view of the camera may be greater than or less than that of the user. In embodiments, if the field of view is less than that of the user, one or more additional photos may be captured and stitched together using techniques that are known in the art to create a composite image having a field of view that is closer to that of the user. In the example provide in FIG. 13, dashed line 1330 represents an image captured by a camera of an AR/VR headset according to embodiments of the invention.

In embodiments, the AR/VR headset may receive captured images from multiple cameras. In embodiments, the cameras may comprise lenses of different focal lengths that provide different fields of view. For example, a camera with a wide angle lens will capture a wider field of view (possibly even wider than that of the user) while a camera with a telephoto lens may capture a field of view that is much narrower than that of the user (which causes objects in the narrower field of view to appear magnified). One skilled in the art will recognize that the present invention may use images captured from any such cameras.

In embodiments, the AR/VR headset determines 1240 an enhancement position in the at least one captured image that corresponds to the target position. In embodiments, software and/or hardware executing on the AR/VR headset maps the target position to a corresponding portion of the captured image. In embodiments, the AR/VR headset is calibrated such that a target position can be mapped to a portion of an image of at least a portion of the user's field of view captured by a respective camera.

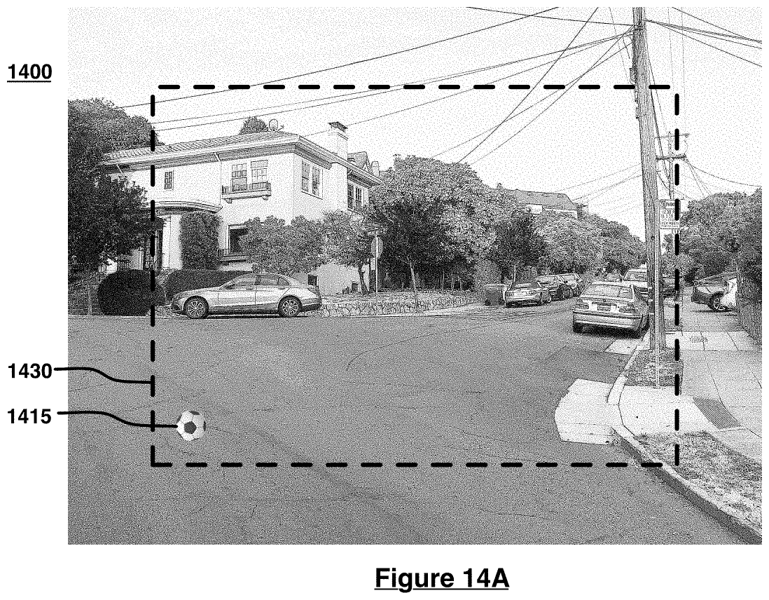

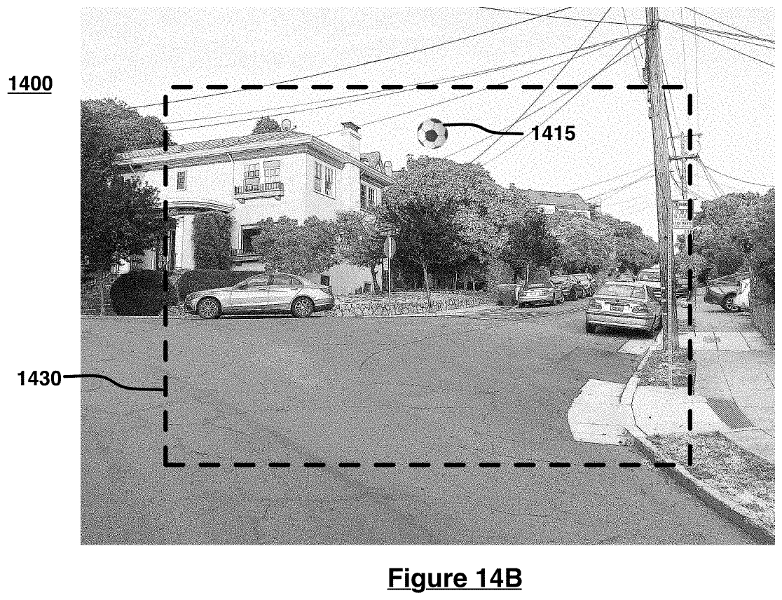

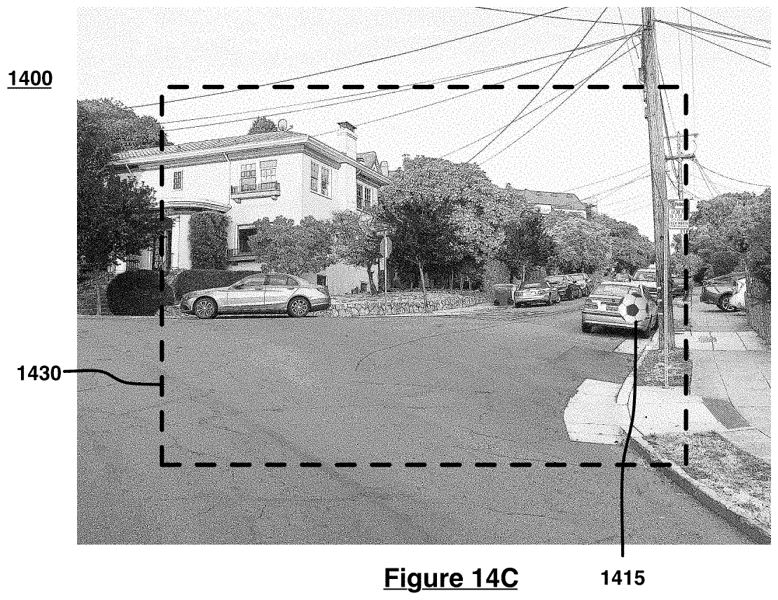

In embodiments, an AR/VR headset may be calibrated by positioning a view target (e.g., a known image, such as a logo, etc.) at different positions within the user's field of view and mapping eye/gaze tracking data associated with viewing the view target to the position of the view target in a captured image of at least a portion of the user's field of view. For example, FIGS. 14A-C show a view target 1415 that is positioned at different locations within a user's field of view 1400. In FIGS. 14A-C, the view target 1415 is also within the field of view captured by a camera, which is represented by dashed line 1430. In embodiments, eye/gaze tracking data is captured and stored while the user is focused on the view target at each of the various positions. For each view target position at which the eye/gaze tracking data is collected, an image of at least a portion of the user's field of view is captured. In embodiments, object detection is performed on the captured images to identify the location of the view target in the captured image. One skilled in the art will recognize that there are a number of object detection techniques that may be used, including a neural network trained to detect the view target in an image. In embodiments, a table or other data structure maps the eye/gaze tracking data with the corresponding location of the view target in the captured image. In embodiments, the AR/VR headset may use the table or other data structure to map (e.g., through interpolation) eye/gaze tracking data to a location within an image of the user's field of view captured contemporaneously with the eye/gaze tracking data.

In embodiments in which an external camera is used, an image captured with the external camera may be compared to an image captured by the headset to identify overlapping regions as is known in the art. Once the overlap has been determined, the target position may be mapped to the image captured by the external camera.

In embodiments, an enhanced (e.g. magnified) view of an area associated with the enhancement position is generated 1250. In embodiments, an area (e.g., circular area, rectangular area, etc.) around the enhancement position in the captured image is magnified through a digital zoom process. For example, in embodiments, an area surrounding the portion of the captured image that was identified as corresponding to the target position may be cropped from the captured image and magnified/upscaled to a higher resolution by interpolating additional pixel values. One skilled in the art will recognize that there are a variety of methods for performing the upscaling, which fall within the scope of the present invention. As upscaling may introduce the jagged/blocky patterns into the image, anti-aliasing techniques may be applied to smooth the appearance of the magnified/upscaled image.

In embodiments, the captured image may come from a camera with a long focal length (e.g., a zoom lens), which produces an image with higher magnification than the user's vision. In embodiments, the AR/VR headset identifies the enhancement position of the higher magnification image that corresponds to the target position. In such embodiments, the enhanced view comprises an area around the enhancement position that is cropped/extracted from the higher magnification image.

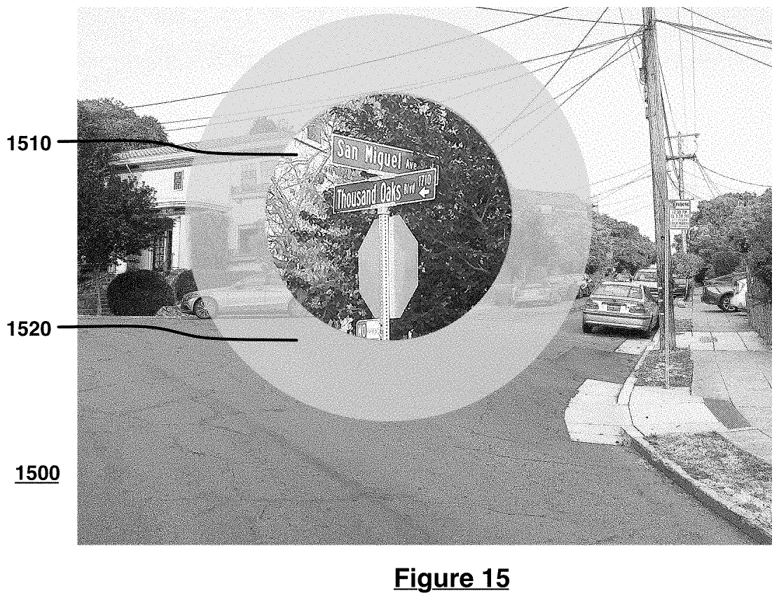

In embodiments, the enhanced view (e.g. magnified view) is displayed 1260 to the user through the virtual view (e.g., augmented reality view, virtual reality view, etc.) provided by the AR/VR headset. For example, FIG. 15 represents a virtual view 1500 viewed through an AR/VR headset according to embodiments of the invention. FIG. 15 comprises a magnified view 1510 displayed in the user's field of view through a virtual view 1500 provided by an AR/VR headset according to embodiments of the invention. While magnified view 1510 is circular in FIG. 15, one skilled in the art will recognize that the magnified view could take on other shapes as well, including rectangles. In embodiments, the magnified view 1510 may appear to move more drastically than the user's field of view as the user moves his/her head. To provide a better user experience, optical and/or digital image stabilization techniques may be used to stabilize the magnified view 1510 for the user. Such stabilization techniques are well known to one skilled in the art.

In FIG. 15, magnified view 1510 corresponds to an area around the target position 1520 from FIG. 13. In embodiments, the magnified view 1510 is surrounded by a border region 1520 that helps to separate the magnified view 1510 from the rest of the user's field of view. In embodiments, the border region 1520 provides a more visually appealing transition from the user's actual view to the portion that is magnified. In the embodiment of FIG. 15, the border region 1520 is partially translucent such that the user's field of behind border region 1520 is partially visible. This helps to highlight the magnified portion while still allowing the user to see the area covered by the border. In alternative embodiments, the border region 1520 may be completely opaque (e.g., black). In yet another alternative, the transparency of the border region 1520 may be foveated such that the level of transparency varies across the border region 1520. For example, the transparency of the border region 1520 may increase as the distance from the magnified view 1510 increases.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A method for displaying content in a virtual view provided by a device comprising:
receiving a request to display first content;
displaying the first content in a first tile at a first location in the virtual view;
detecting a user's gaze within a first designated region of the first content;
responsive to detecting the user's gaze within the first designated region, displaying second content in a second tile at a second location in the virtual view.

2. The method of claim 1, wherein the second content is associated with the first designated region.

3. The method of claim 1, wherein the first content is an electronic document.

4. The method of claim 3, wherein the second content comprises a figure from the electronic document.

5. The method of claim 1, wherein detecting a user's gaze within a first designated region of the first content comprises:
determine a gaze point of a user based at least in part on a captured image of at least one of the user's eyes or the orientation of the device;
comparing the gaze point to a position of the first designated region within the virtual view to determine if the gaze point intersects the first designated region.

6. The method of claim 1, wherein the virtual view is displayed to the user via one or more light emitting diodes that are part of the device and whose light is projected towards one or more lenses comprising one or more waveguides that reflect the light into one or more eyes of the user of the device.

7. The method of claim 1 further comprising:
detecting a user's gaze within a second designated region of the first content; and
responsive to detecting the user's gaze within the second designated region, displaying third content in the second tile, the third content associated with the second designated region.

8. A device for providing a virtual view to a user, comprising:
at least one non-transitory computer readable medium that stores instructions that when executed enable the device to:
display first content in a first tile at a first location in the virtual view;
detect a user's gaze within a first designated region of the first content;
responsive to detecting the user's gaze within the first designated region, display second content in a second tile at a second location in the virtual view;
at least one processing circuit, coupled to the at least one non-transitory computer readable medium, that receives one or more instructions stored in the at least one non-transitory computer readable medium and executes the one or more instructions to generate output data; and
a display circuit, coupled to the at least one processing circuit, that receives the output data and causes the output data to be displayed in the virtual view.

9. The device of claim 8, wherein the display circuit causes the output data to be displayed in the virtual view by outputting second data that is used to control or alter light from a light source used by the device to provide the virtual view.

10. The device of claim 9, wherein the light source comprises one or more light emitting diodes whose light is projected from the device toward one or more lenses that comprise one or more waveguides that reflect the light into at least one eye of the user of the device to provide the virtual view.

11. The device of claim 8, wherein the device is a wearable headset and wherein the virtual view is an augmented reality view that is presented within the user's field of view.

12. The device of claim 8, wherein the second content is associated with the first designated region.

13. The device of claim 8, wherein the first content is an electronic document.

14. The device of claim 13, wherein the second content is a figure from the electronic document.

15. The device of claim 8, wherein the instructions that enable the device to detect a user's gaze within a first designated region of the first content comprise instructions that enable the device to:
determine a gaze point of a user based at least in part on a captured image of at least one of the user's eyes or the orientation of the device;
compare the gaze point to a position of the first designated region within the virtual view to determine if the gaze point intersects the first designated region.

16. The device of claim 8, wherein the at least one non-transitory computer readable medium stores additional instructions that when executed enable the device to;
detect a user's gaze within a second designated region of the first content; and
responsive to detecting the user's gaze within the second designated region, display third content in the second tile, the third content associated with the second designated region.

17. At least one non-transitory computer readable medium that stores instructions that when executed by one or more processing circuits enable a device to:
receive a request to display first content;
display the first content in a first tile at a first location in the virtual view;
detect a user's gaze within a first designated region of the first content;
responsive to detecting the user's gaze within the first designated region, display second content in a second tile at a second location in the virtual view.

18. The at least one non-transitory computer readable medium of claim 17, wherein the second content is associated with the first designated region.

19. The at least one non-transitory computer readable medium of claim 17, wherein the instructions that enable the device to detect a user's gaze within a first designated region of the first content comprise instructions that enable the device to:
determine a gaze point of a user based at least in part on a captured image of at least one of the user's eyes or the orientation of the device;
compare the gaze point to a position of the first designated region within the virtual view to determine if the gaze point intersects the first designated region.

20. The at least one non-transitory computer readable medium of claim 17 further comprising instructions that enable the device to:
detect a user's gaze within a second designated region of the first content; and
responsive to detecting the user's gaze within the second designated region, display third content in the second tile, the third content associated with the second designated region.
